(19) United States
(12) Patent Application Publication
(10) Pub. No.: US 2023/0232821 A1
(43) Pub. Date: Jul. 27, 2023

(54) A STABLE, SOLVENT-FREE, SELF-EMULSIFIABLE CONCENTRATE

(71) Applicant: BASF SE, Ludwigshafen am Rhein (DE)

(72) Inventors: Rodney F. Klima, Cincinnati, OH (US); Dean A. Oester, Cincinnati, OH (US)

(21) Appl. No.: 18/001,831

(22) PCT Filed: Jun. 10, 2021
(86) PCT No.: PCT/EP2021/065641

§ 371 Date: Dec. 14, 2022

Related U.S. Application Data
(60) Provisional application No. 63/039,135, filed on Jun. 15, 2020.

(30) Foreign Application Priority Data
Jul. 28, 2020 (EP) 20188107.5

(51) Int. Cl. A01N 25/04; A01N 25/30; A01N 53/00; A01N 43/653; A01P 3/00; A01P 7/04

(52) U.S. Cl. CPC A01N 25/04; A01N 25/30; A01N 53/00; A01N 43/653; A01P 3/00; A01P 7/04

(57) ABSTRACT

Disclosed herein is a stable, solvent free, self emulsifiable concentrate including a biocide and an ethoxylated fatty acid alkyl ester of formula (I). Additionally disclosed herein is a method of forming the stable, solvent free, self emulsifiable concentrate. Additionally disclosed herein is a kit for preparing the concentrate, including as separate components a biocide and an ethoxylated fatty acid alkyl ester of formula (I). Further disclosed herein is a method of using the concentrate for the treatment of plants and soil, lawns and gardens, and buildings and other surfaces and structures where pests reside.

### FIELD OF INVENTION

The present invention relates to a stable, solvent free, self emulsifiable concentrate comprising a biocide and an ethoxylated fatty acid alkyl ester of formula (I). The present invention also relates to a method of forming the stable, solvent free, self emulsifiable concentrate. The present invention further relates to a kit for preparing the concentrate, comprising as separate components a biocide and an ethoxylated fatty acid alkyl ester of formula (I). The present invention also relates to use of the presently claimed concentrate for the treatment of plants and soil, lawns and gardens, and buildings and other surfaces and structures where pests reside.

### BACKGROUND OF THE INVENTION

A composition with a biocide is essential for pest control. The composition reduces the presence of harmful organisms (such as insects) and plants (such as weeds) that decrease crop yield and crop quality.

The biocides such as pesticides, insecticides, herbicides, fungicides, rodenticides, growth regulators, and the like are presented in fields as dips, forms of wettable powders, miscible oils (also known as emulsifiable concentrates) i.e. ECs. The compositions also contain multiple components i.e. solvents, co-solvents, surfactants, and/or emulsifiers. The compositions are either sprayed or are used to perform dip washing.

The compositions are applied in large quantities or in repeated manner to ensure coverage of the biocide. The compositions with miscible oils when used engage high content of solvents. Further, such compositions also use other components to reduce viscosity of the composition, or to stabilise or to dilute the miscible oils.

Presence of the multiple components also renders the composition rather complex. The need for these multiple components adds complexity in the manufacturing of the commercial pesticide product throughout the manufacturing process, from supply logistics of multiple raw materials to handling and use of multiple raw materials in production units.

U.S. Pat. No. 6,068,849A provide for in-can formulations and tank mixes. However, the pesticidal concentrate provided requires additional solvents or additional surfactants.

Thus, it was an object of the present invention to provide a concentrate with biocide which does not require solvent(s) which is produced in a less complex manufacturing process, is easy to be handled, transported and remains stable on shelf.

### SUMMARY OF THE INVENTION

Surprisingly, it has been found that by adding certain ethoxylated fatty acid alkyl esters to biocide, stable, solvent-free concentrate is obtained. The resulting concentrate is self emulsifiable and obviates the need of additional components such as solvents, or additional emulsifiers.

Accordingly, in one aspect, the present invention is directed to a stable, solvent-free, self-emulsifiable concentrate comprising:

a. at least one biocide, and

b. at least one ethoxylated fatty acid alkyl ester of general formula (I);

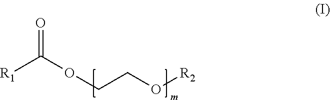

wherein
R₁ is selected from linear or branched, acyclic or cyclic, substituted or unsubstituted C₃ to C₂₀ alkyl or C₃ to C₂₀ alkenyl,
m is an integer in the range of 2 to 30, and
R₂ is selected from linear or branched, acyclic or cyclic, substituted or un-substituted C₁ to C₁₀ alkyl.

In another aspect, the present invention is directed to a method of forming the above defined self-emulsifiable concentrate. The method comprising the step of mixing the at least one biocide with the at least one ethoxylated fatty acid alkyl ester of general formula (I).

In another aspect, the present invention is directed to the use of the above defined concentrate for treatment of soil and plants lawns and gardens, and buildings and other surfaces and structures where pests reside.

In another aspect, the present invention is directed to a kit for preparing the above defined concentrate comprising, as separate components, (a) the at least one biocide, and (b) the at least one ethoxylated fatty acid alkyl ester of general formula (I).

### DETAILED DESCRIPTION OF THE INVENTION

Before the present compositions, concentrates and formulations of the invention are described, it is to be understood that this invention is not limited to particular compositions, concentrates and formulations described, since such compositions, concentrates and formulation may, of course, vary. It is also to be understood that the terminology used herein is not intended to be limiting, since the scope of the present invention will be limited only by the appended claims.

If hereinafter a group is defined to comprise at least a certain number of embodiments, this is meant to also encompass a group which preferably consists of these embodiments only. Furthermore, the terms “first”, “second”, “third” or “(a)”, “(b)”, “(c)”, “(d)” etc. and the like in the description and in the claims, are used for distinguishing between similar elements and not necessarily for describing a sequential or chronological order. It is to be understood that the terms so used are interchangeable under appropriate circumstances and that the embodiments of the invention described herein are capable of operation in other sequences than described or illustrated herein. In case the terms “first”, “second”, “third” or “(A)”, “(B)” and “(C)” or “(a)”, “(b)”, “(c)”, “(d)”, “i”, “ii” etc. relate to steps of a method or use or assay there is no time or time interval coherence between the steps, that is, the steps may be carried out simultaneously or there may be time intervals of seconds, minutes, hours, days, weeks, months or even years between such steps, unless otherwise indicated in the application as set forth herein above or below.

In the following passages, different aspects of the invention are defined in more detail. Each aspect so defined may be combined with any other aspect or aspects unless clearly indicated to the contrary. In particular, any feature indicated as being preferred or advantageous may be combined with any other feature or features indicated as being preferred or advantageous.

Reference throughout this specification to “one embodiment” or “an embodiment” means that a particular feature, structure or characteristic described in connection with the embodiment is included in at least one embodiment of the present invention. Thus, appearances of the phrases “in one embodiment” or “in an embodiment” in various places throughout this specification are not necessarily all referring to the same embodiment but may do so. Furthermore, the particular features, structures or characteristics may be combined in any suitable manner, as would be apparent to a person skilled in the art from this disclosure, in one or more embodiments. Furthermore, while some embodiments described herein include some, but not other features included in other embodiments, combinations of features of different embodiments are meant to be within the scope of the invention, and form different embodiments, as would be understood by those in the art. For example, in the appended claims, any of the claimed embodiments can be used in any combination.

Further, it shall be noted that the terms “at least one”, “one or more” or similar expressions indicating that a feature or element may be present once or more than once typically will be used only once when introducing the respective feature or element. In the following, in most cases, when referring to the respective feature or element, the expressions “at least one” or “one or more” will not be repeated, non-withstanding the fact that the respective feature or element may be present once or more than once.

Furthermore, the ranges defined throughout the specification include the end values as well, i.e. a range of 1 to 10, between 1 to 10 imply that both 1 and 10 are included in the range. For the avoidance of doubt, the applicant shall be entitled to any equivalents according to applicable law.

As defined herein “stable concentrate” is a concentrate that does not exhibits phase separation on exposure or remains physically and chemically unreactive to the environment it is produced and stored as well as delivers acceptable levels of biological efficacy when used within defined periods of time.

As defined herein “solvent free concentrate” is a concentrate that does not contain solvent or contains less than 0.01% by weight of solvent. Solvent include the polar and the non-polar organic solvent excluding water.

As defined herein “self-emulsifiable concentrate” is a concentrate that when mixed in an aqueous formulation forms an emulsion without the requirement of addition of any external emulsion aid.

As defined herein “biocides” are selected from pesticides, safeners and/or growth regulators. The pesticides are further defined as fungicides, insecticides, nematicides, herbicides.

Certain terms are first defined so that this disclosure can be more readily understood. Unless defined otherwise, all technical and scientific terms used herein have the same meaning as commonly understood by one of ordinary skill in the art to which embodiments of the invention pertain.

An aspect of the present invention is directed to a stable, solvent-free, self-emulsifiable concentrate comprising:

a. at least one biocide, and

b. at least one ethoxylated fatty acid alkyl ester of general formula (I);

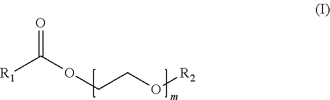

wherein
R₁ is selected from linear or branched, acyclic or cyclic, substituted or unsubstituted C₃ to C₂₀ alkyl or C₃ to C₂₀ alkenyl,
m is an integer in the range of 2 to 30, and
R₂ is selected from linear or branched, acyclic or cyclic, substituted or unsubstituted C₁ to C₁₀ alkyl.

In an embodiment, the concentrate of the present invention comprises at least one biocide. The at least one biocide is a pesticide. The pesticide is selected from fungicides, insecticides and herbicides. Mixtures of pesticides of two or more of the abovementioned classes may also be used.

In an embodiment, the amount of the at least one biocide is in the range of 0.2 wt. % to 20.0 wt. %, based on the final weight of the concentrate.

In an embodiment, the amount of the at least one biocide is in the range of 0.2 wt. % to 15.0 wt. %, based on the final weight of the concentrate.

In another embodiment, the amount of the at least one biocide is in the range of 0.2 wt. % to 10.0 wt. %, based on the final weight of the concentrate.

In still another embodiment, the amount of the at least one biocide is in the range of 0.2 wt. % to 5.0 wt. %, based on the final weight of the concentrate.

In an embodiment, the amount of the at least one biocide is in the range of 0.25 wt. % to 4.5 wt. %, based on the final weight of the concentrate.

In an embodiment, the amount of the at least one biocide is in the range of 0.25 wt. % to 4.0 wt. %, based on the final weight of the concentrate.

The skilled person is familiar with such pesticides, which can be found, for example, in the Pesticide Manual, 15th Ed. (2009), The British Crop Protection Council, London. The following list gives examples of pesticides which may be used as pesticide.

In yet another embodiment of the present invention, the fungicide is selected from respiration inhibitors, sterol biosynthesis inhibitors, nucleic acid synthesis inhibitors, inhibitors of cell division and cytoskeleton, inhibitors of amino acid and protein synthesis, signal transduction inhibitors, protein inhibitors, lipid and membrane synthesis inhibitors, inhibitors with multi-site action, cell wall synthesis inhibitors, plant defense inducers, and mixtures thereof.

In an embodiment of the present invention, the fungicide is selected from

### A. Respiration Inhibitors:

1. Inhibitors of complex III at Qo site (e.g. strobilurins): azoxystrobin, coumethoxystrobin, cou moxystrobin, dimoxystrobin, enestroburin, fenaminstrobin, fenoxystrobin/flufenoxystrobin, fluoxastrobin, kresoxim-methyl, metominostrobin, orysastrobin, picoxystrobin, pyraclostrobin, pyrametostrobin, pyraoxystrobin, trifloxystrobin, 2-[2-(2,5-dimethyl-phenoxymethyl)-phenyl]-3-methoxy-acrylic acid methyl ester and 2-(2-(3-(2,6-dichlorophenyl)-1-methyl-allylideneaminooxymethyl)-phenyl)-2-methoxyimino-N-methyl-acetamide, pyribencarb, triclopyri carb/chlorodincarb, famoxadone, fenamidone;

2. Inhibitors of complex III at Qi site: cyazofamid, amisulbrom, [(3S,6S,7R,8R)-8-benzyl-3-[(3-acetoxy-4-methoxy-pyridine-2-carbonyl)amino]-6-methyl-4,9-dioxo-1,5-dioxonan-7-yl]2-methylpropanoate, [(3S,6S,7R,8R)-8-benzyl-3-[[3-(acetoxymethoxy)-4-methoxy-pyridine-2-carbonyl]amino]-6-methyl-4,9-dioxo-1,5-dioxonan-7-yl] 2-methylpropanoate,[(3S,6S,7R,8R)-8-benzyl-3-[(3-isobutoxycarbonyloxy-4-methoxy-pyridine-2-carbonyl)amino]-6-methyl-4,9-dioxo-1,5-dioxonan-7-yl] 2-methylpropanoate, [(3S,6S,7R,8R)-8-benzyl-3-[[3-(1,3-benzodioxol-5-ylmethoxy)-4-methoxy-pyridine-2-carbonyl]amino]-6-methyl-4,9-dioxo-1,5-dioxonan-7-yl] 2-methylpropanoate;

3. Inhibitors of complex II (e. g. carboxamides): benodanil, bixafen, boscalid, carboxin, fenfuram, fluopyram, flutolanil, fluxapyroxad, furametpyr, isopyrazam, mepronil, oxycarboxin, penflufen, penthiopyrad, sedaxane, tecloftalam, thifluzamide, N-(4′-trifluoromethylthiobiphenyl-2-yl)-3-difluoromethyl-1-methyl-1H-pyrazole-4-carboxamide, N-(2-(1,3,3-trimethyl-butyl)-phenyl)-1,3-dimethyl-5-fluoro-1H-pyrazole-4-carboxamide, N-[9-(dichloromethylene)-1,2,3,4-tetrahydro-1,4-methanonaphthalen-5-yl]-3-(difluoromethyl)-1-methyl-1H-pyrazole-4-carboxamide;

4. Other respiration inhibitors (e.g. complex I, uncouplers): diflumetorim, (5,8-difluoroquinazolin-4-yl)-{2-[2-fluoro-4-(4-trifluoromethylpyridin-2-yloxy)-phenyl]-ethyl}-amine; nitrophenyl derivates: binapacryl, dinobuton, dinocap, fluazinam; ferimzone; organometal compounds: fentinsalts, such as fentin-acetate, fentin chloride or fentin hydroxide; ametoctradin; and silthiofam;

### B. Sterol Biosynthesis Inhibitors (SBI Fungicides):

1. C14 demethylase inhibitors (DMI fungicides): triazoles: azaconazole, bitertanol, bromuconazole, cyproconazole, difenoconazole, diniconazole, diniconazole-M, epoxiconazole, fenbuconazole, fluquinconazole, flusilazole, flutriafol, hexaconazole, imibenconazole, ipconazole, metconazole, myclobutanil, oxpoconazole, paclobutrazole, penconazole, propiconazole, prothioconazole, simeconazole, tebuconazole, tetraconazole, triadimefon, triadimenol, triticonazole, uniconazole; imidazoles: imazalil, pefurazoate, prochloraz, triflumizol; pyrimidines, pyridines and piperazines: fenarimol, nuarimol, pyrifenox, triforine;

2. Delta14-reductase inhibitors: aldimorph, dodemorph, dodemorph-acetate, fenpropimorph, tridemorph, fenpropidin, piperalin, spiroxamine; Inhibitors of 3-keto reductase: fenhexamid;

### C. Nucleic Acid Synthesis Inhibitors

1. Phenylamides or acyl amino acid fungicides: benalaxyl, benalaxyl-M, kiralaxyl, metalaxyl, metalaxyl-M (mefenoxam), ofurace, oxadixyl;

2. Others: hymexazole, octhilinone, oxolinic acid, bupirimate, 5-fluorocytosine, 5-fluoro-2-(ptolylmethoxy) pyrimidin-4-amine, 5-fluoro-2-(4-fluorophenylmethoxy)pyrimidin-4-amine;

### D. Inhibitors of Cell Division and Cytoskeleton

1. Tubulin inhibitors, such as benzimidazoles, thiophanates: benomyl, carbendazim, fuberidazole, thiabendazole, thiophanate-methyl; triazolopyrimidines: 5-chloro-7-(4-methylpiperidin-1-yl)-6-(2,4,6-trifluorophenyl)-[1,2,4]triazolo[1,5-a]pyrimidine

2. Other cell division inhibitors: diethofencarb, ethaboxam, pencycuron, fluopicolide, zoxamide, metrafenone, pyriofenone;

### E. Inhibitors of Amino Acid and Protein Synthesis

1. Methionine synthesis inhibitors (anilino-pyrimidines): cyprodinil, mepanipyrim, pyrimethanil;

2. Protein synthesis inhibitors: blasticidin-S, kasugamycin, kasugamycin hydrochloride-hydrate, mildiomycin, streptomycin, oxytetracyclin, polyoxine, validamycin A;

### F. Signal Transduction Inhibitors

1. MAP/histidine kinase inhibitors: fluoroimid, iprodione, procymidone, vinclozolin, fenpiclonil, fludioxonil;

2. G protein inhibitors: quinoxyfen;

### G. Lipid and Membrane Synthesis Inhibitors

1. Phospholipid biosynthesis inhibitors: edifenphos, iprobenfos, pyrazophos, isoprothiolane;

2. Lipid peroxidation: dicloran, quintozene, tecnazene, tolclofos-methyl, biphenyl, chloroneb, etridiazole;

3. Phospholipid biosynthesis and cell wall deposition: dimethomorph, flumorph, mandipropamid, pyrimorph, benthiavalicarb, iprovalicarb, valifenalate and N-(1-(1-(4-cyano-phenyl)-ethanesulfonyl)-but-2-yl) carbamic acid-(4-fluorophenyl) ester;

4. Compounds affecting cell membrane permeability and fatty acides: propamocarb, propamocarb-hydrochloride;

H. Inhibitors with Multi Site Action

1. Inorganic active substances: Bordeaux mixture, copper acetate, copper hydroxide, copperoxychloride, basic copper sulfate, sulfur;

2. Thio- and dithiocarbamates: ferbam, mancozeb, maneb, metam, metiram, propineb, thiram, zineb, ziram;

3. Organochlorine compounds (e.g. phthalimides, sulfamides, chloronitriles): anilazine, chlorothalonil, captafol, captan, folpet, dichlofluanid, dichlorophen, flusulfamide, hexachlorobenzene,pentachlorphenole and its salts, phthalide, tolylfluanid, N-(4-chloro-2-nitro-phenyl)-Nethyl-4-methyl-benzenesulfonamide;

4. Guanidines and others: guanidine, dodine, dodine free base, guazatine, guazatine-acetate, iminoctadine, iminoctadine-triacetate, iminoctadine-tris(albesilate), dithianon;

### I. Cell Wall Synthesis Inhibitors

1. Inhibitors of glucan synthesis: validamycin, polyoxin B; melanin synthesis inhibitors: pyroquilon, tricyclazole, carpropamid, dicyclomet, fenoxanil;

### J. Plant Defence Inducers

1. Acibenzolar-S-methyl, probenazole, isotianil, tiadinil, prohexadione-calcium; phosphonates: fosetyl, fosetyl-aluminum, phosphorous acid and its salts;

### K. Unknown Mode of Action

1. Bronopol, chinomethionat, cyflufenamid, cymoxanil, dazomet, debacarb, diclomezine, difenzoquat, difenzoquat-methylsulfate, diphenylamin, fenpyrazamine, flumetover, flusulfamide, flutianil, methasulfocarb, nitrapyrin, nitrothal-isopropyl, oxin-copper, proquinazid, tebufloquin, tecloftalam, triazoxide, 2-butoxy-6-iodo-3-propylchromen-4-one, N-(cyclopropylmethoxyimino-(6-difluoro-methoxy-2,3-difluoro-phenyl)-methyl)-2-phenyl acetamide, N′-(4-(4-chloro-3-trifluoromethyl-phenoxy)-2,5-dimethyl-phenyl)-N-ethyl-N-methyl formamidine, N′-(4-(4-fluoro-3-trifluoromethyl-phenoxy)-2,5-dimethyl-phenyl)-N-ethyl-N-methyl formamidine, N′-(2-methyl-5-trifluoromethyl-4-(3-trimethylsilanyl-propoxy)-phenyl)-N-ethyl-Nmethyl formamidine, N′-(5-difluoromethyl-2-methyl-4-(3-trimethylsilanyl-propoxy)-phenyl)-Nethyl-N-methyl formamidine, 2-{1-[2-(5-methyl-3-trifluoromethyl-pyrazole-1-yl)-acetyl]-piperidin-4-yl}-thiazole-4-carboxylic acid methyl-(1,2,3,4-tetrahydro-naphthalen-1-yl)-amide, 2-{1-[2-(5-methyl-3-trifluoromethyl-pyrazole-1-yl)-acetyl]-piperidin-4-yl}-thiazole-4-carboxylic acid methyl-(R)-1,2,3,4-tetrahydro-naphthalen-1-yl-amide, 1-[4-[4-[5-(2,6-difluorophenyl)-4,5-dihydro-3-isoxazolyl]-2-thiazolyl]-1-piperidinyl]-2-[5-methyl-3-(trifluoromethyl)-1H-pyrazol-1-yl]ethanone, methoxy-acetic acid 6-tert-butyl-8-fluoro-2,3-dimethyl-quinolin-4-yl ester, N-Methyl-2-{1-[(5-methyl-3-trifluoro methyl-1H-pyrazol-1-yl)-acetyl]-piperidin-4-yl}-N-[(1R)-1,2,3,4-tetrahydronaphthalen-1-yl]-4-thiazolecarboxamide, 3-[5-(4-methylphenyl)-2,3-dimethyl-isoxazolidin-3-yl]-pyridine, 3-[5-(4-chloro-phenyl)-2,3-dimethyl-isoxazolidin-3-yl]-pyridine (pyrisoxazole), N-(6-methoxy-pyridin-3-yl) cyclopropanecarboxylic acid amide, 5-chloro-1-(4,6-dimethoxy-pyrimidin-2-yl)-2-methyl-1H-benzoimidazole, 2-(4-chloro-phenyl)-N-[4-(3,4-dimethoxy-phenyl)-isoxazol-5-yl]-2-prop-2-ynyloxy-acetamide;

### L. Antifungal Biocontrol Agents, Plant Bioactivators:

1. Ampelomyces quisqualis (e.g. AQ 10@ from Intrachem Bio GmbH & Co. KG, Germany), Aspergillus flavus (e.g. AFLAGUARD® from Syngenta, CH), Aureobasidium pullulans (e.g. BOTECTOR® from bio-ferm GmbH, Germany), Bacillus pumilus (e.g. NRRL Accession No. B-30087 in SONATA® and BALLAD®, Plus from AgraQuest Inc., USA), Bacillus subtilis (e.g. isolate NRRL-Nr. B-21661 in RHAPSODY®, SERENADE® MAX and SERENADE® ASO from AgraQuest Inc., USA), Bacillus subtilis var. amyloliquefaciens FZB24 (e.g. TAEGRO® from Novozyme Biologicals, Inc., USA), Candida oleophila I-82 (e.g. ASPIRE® from Ecogen Inc., USA), Candida saitoana (e.g. BIOCURE® (in mixture with lysozyme) and BIOCOAT® from Micro Flo Company, USA (BASF SE) and Arysta), Chitosan (e.g. ARMOUR-ZEN from BotriZen Ltd., NZ), Clonostachys rosea f. catenulata, also named Gliocladium catenulatum (e.g. isolate J1446:PRESTOP@ from Verdera, Finland), Coniothyrium minitans (e.g. CONTANS® from Prophyta, Germany), Cryphonectria parasitica (e.g. Endothia parasitica from CNICM, France), Cryptococcusalbidus (e.g. YIELD PLUS® from Anchor Bio-Technologies, South Africa), Fusariumoxysporum (e.g. BIOFOX® from S.I.A.P.A., Italy, FUSACLEAN® from Natural Plant Protection, France), Metschnikowia fructicola (e.g. SHEMER® from Agrogreen, Israel), Microdochium dimerum (e.g. ANTIBOT® from Agrauxine, France), Phlebiopsis gigantea (e.g. ROTSOP® from Verdera, Finland), Pseudozyma flocculosa (e.g. SPORODEX® from Plant Products Co. Ltd., Canada), Pythium oligandrum DV74 (e.g. POLYVERSUM® from Remeslo SSRO, Biopreparaty, Czech Rep.), Reynoutria sachlinensis (e.g. REGALIA® from Marrone BioInnovations, USA), Talaromyces flavus V117b (e.g. PROTUS® from Prophyta, Germany), Trichoderma asperellum SKT-1 (e.g. ECO-HOPE® from Kumiai Chemical Industry Co., Ltd., Japan), T. atroviride LC52 (e.g. SENTINEL® from Agrimm Technologies Ltd, NZ), T. harzianum T-22 (e.g. PLANTSHIELD® der Firma BioWorks Inc., USA), T. harzianum TH 35 (e.g. ROOT PRO® from Mycontrol Ltd., Israel), T. harzianum T-39 (e.g. TRICHODEX® and TRICHODERMA 2000@ from Mycontrol Ltd., Israel and Makhteshim Ltd., Israel), T. harzianum and T. viride (e.g. TRICHOPEL from Agrimm Technologies Ltd, NZ), T. harzianum ICCO12 and T. viride ICCO80 (e.g. REMEDIER® WP from Isagro Ricerca, Italy), T. polysporum and T. harzianum (e.g. BINAB® from BINAB Bio-Innovation AB, Sweden), T. stromaticum (e.g. TRICOVAB® from C.E.P.L.A.C., Brazil), T. virens GL-21 (e.g. SOILGARD® from Certis LLC, USA), T. viride (e.g. TRIECO® from Ecosense Labs. (India) Pvt. Ltd., Indien, BIO-CURE® F from T. Stanes & Co. Ltd., Indien), T. viride TV1 (e.g. T. viride TV1 from Agribiotec srl, Italy), and Ulocladium oudemansii HRU3 (e.g. BOTRY-ZEN® from Botry-Zen Ltd,NZ).

In an embodiment of the present invention the herbicide is selected from acetamides, amino acid derivatives, aryloxyphenoxypropionates, bipyridyls, (thio)carbamates, cyclohexanediones, dinitroanilines, diphenyl ethers, hydroxybenzonitriles, imidazolinones, phenoxy acetic acids, pyrazines, pyridines, sulfonylureas, triazines, ureas, pyrimidinedione, acetolactate synthase inhibitors, and mixtures thereof.

In an embodiment of the present invention the herbicide is selected from:

A. Acetamides: acetochlor, alachlor, butachlor, dimethachlor, dimethenamid, flufenacet, mefenacet, metolachlor, metazachlor, napropamide, naproanilide, pethoxamid, pretilachlor, propachlor, thenylchlor;
B. Amino acid derivatives: bilanafos, glyphosate, glufosinate, sulfosate;
C. Aryloxyphenoxypropionates: clodinafop, cyhalofop-butyl, fenoxaprop, fluazifop, haloxyfop, metamifop, propaquizafop, quizalofop, quizalofop-P-tefuryl;
D. Bipyridyls: diquat, paraquat;
E. (thio)carbamates: asulam, butylate, carbetamide, desmedipham, dimepiperate, eptam (EPTC), esprocarb, molinate, orbencarb, phenmedipham, prosulfocarb, pyributicarb, thiobencarb, triallate;
F. Cyclohexanediones: butroxydim, clethodim, cycloxydim, profoxydim, sethoxydim, tepraloxydim, tralkoxydim;
G. Dinitroanilines: benfluralin, ethalfluralin, oryzalin, pendimethalin, prodiamine, trifluralin;
H. Diphenyl ethers: acifluorfen, aclonifen, bifenox, diclofop, ethoxyfen, fomesafen, lactofen, oxyfluorfen;
I. Hydroxybenzonitriles: bomoxynil, dichlobenil, ioxynil;
J. Imidazolinones: imazamethabenz, imazamox, imazapic, imazapyr, imazaquin, imazethapyr;
K. Phenoxy acetic acids: clomeprop, 2,4-dichlorophenoxyacetic acid (2,4-D), 2,4-DB, dichlorprop, MCPA, MCPA-thioethyl, MCPB, Mecoprop;
L. Pyrazines: chloridazon, flufenpyr-ethyl, fluthiacet, norflurazon, pyridate;
M. Pyridines: aminopyralid, clopyralid, diflufenican, dithiopyr, fluridone, fluroxypyr, picloram, picolinafen, thiazopyr, triclopyr (2-[(3,5,6-trichloro-2-pyridinyl)oxy] acetic acid, butoxyethyl ester);
N. Sulfonyl ureas: amidosulfuron, azimsulfuron, bensulfuron, chlorimuron-ethyl, chlorsulfuron, cinosulfuron, cyclosulfamuron, ethoxysulfuron, flazasulfuron, flucetosulfuron, flupyrsulfuron, foramsulfuron, halosulfuron, imazosulfuron, iodosulfuron, mesosulfuron, metazosulfuron, metsulfuron-methyl, nicosulfuron, oxasulfuron, primisulfuron, prosulfuron, pyrazosulfuron, rimsulfuron, sulfometuron, sulfosulfuron, thifensulfuron, triasulfuron, tribenuron, trifloxysulfuron, triflusulfuron, tritosulfuron, 1-((2-chloro-6-propyl-imidazo[1,2-b]pyridazin-3-yl)sulfonyl)-3-(4,6-dimethoxy-pyrimidin-2-yl)urea;
O. Triazines: ametryn, atrazine, cyanazine, dimethametryn, ethiozin, hexazinone, metamitron, metribuzin, prometryn, simazine, terbuthylazine, terbutryn, triaziflam;
P. Ureas: chlorotoluron, daimuron, diuron, fluometuron, isoproturon, linuron, methabenzthiazuron, tebuthiuron;
Q. Other acetolactate synthase inhibitors: bispyribac-sodium, cloransulam-methyl, diclosulam, florasulam, flucarbazone, flumetsulam, metosulam, ortho-sulfamuron, penoxsulam, propoxy carbazone, pyribambenz-propyl, pyribenzoxim, pyriftalid, pyriminobac-methyl, pyrimisulfan, pyrithiobac, pyroxasulfone, pyroxsulam;
R. Others: amicarbazone, aminotriazole, anilofos, beflubutamid, benazolin, bencarbazone, benfluresate, benzofenap, bentazone, benzobicyclon, bicyclopyrone, bromacil, bromobutide, butafenacil, butamifos, cafenstrole, carfentrazone, cinidon-ethyl, chlorthal, cinmethylin, clomazone, cumyluron, cyprosulfamide, dicamba, difenzoquat, diflufenzopyr, Drechslera monoceras, endothal, ethofumesate, etobenzanid, fenoxasulfone, fentrazamide, flumiclorac-pentyl, flumioxazin, flupoxam, flurochloridone, flurtamone, indanofan, isoxaben, isoxaflutole, lenacil, propanil, propyzamide, quinclorac, quinmerac, mesotrione, methyl arsenic acid, naptalam, oxadiargyl, oxadiazon, oxaziclomefone, pentoxazone, pinoxaden, pyraclonil, pyraflufen-ethyl, pyrasulfotole, pyrazoxyfen, pyrazolynate, quinoclamine, saflufenacil, sulcotrione, sulfentrazone, terbacil, tefuryltrione, tembotrione, thiencarbazone, topramezone, (3-[2-chloro-4-fluoro-5-(3-methyl-2,6-dioxo-4-trifluoromethyl-5 3,6-dihydro-2Hpyrimidin-1-yl)-phenoxy]-pyridin-2-yloxy)-acetic acid ethyl ester, 6-amino-5-chloro-2-cyclopropyl-pyrimidine-4-carboxylic acid methyl ester, 6-chloro-3-(2-cyclopropyl-6-methylphenoxy)-pyridazin-4-ol, 4-amino-3-chloro-6-(4-chloro-phenyl)-5-fluoro-pyridine-2-carboxylic acid, 4-amino-3-chloro-6-(4-chloro-2-fluoro-3-methoxy-phenyl)-pyridine-2-carboxylic acid methyl ester, and 4-amino-3-chloro-6-(4-chloro-3-dimethylamino-2-fluoro-phenyl)-pyridine-2-carboxylic acid methyl ester.

In an embodiment of the presently claimed invention, the insecticide is selected from organo (thio)phosphates, carbamates, pyrethroids, insect growth regulators, nicotinic receptor agonists/antagonists, macrocyclic lactones, mitochondrial electron transport inhibitors, oxidative phosphorylation inhibitors, moulting disruptor compounds, mixed function oxidase inhibitors, and mixtures thereof.

In an embodiment of the present invention, the insecticide is selected from

A. Organo(thio)phosphates: acephate, azamethiphos, azinphos-methyl, chlorpyrifos, chlorpyrifos-methyl, chlorfenvinphos, diazinon, dichlorvos, dicrotophos, dimethoate, disulfoton, ethion, fenitrothion, fenthion, isoxathion, malathion, methamidophos, methidathion, methylparathion, mevinphos, monocrotophos, oxydemeton-methyl, paraoxon, parathion, phenthoate, phosalone, phosmet, phosphamidon, phorate, phoxim, pirimiphosmethyl, profenofos, prothiofos, sulprophos, tetrachlorvinphos, terbufos, triazophos, trichlorfon;
B. Carbamates: alanycarb, aldicarb, bendiocarb, benfuracarb, carbaryl, carbofuran, carbosulfan, fenoxycarb, furathiocarb, methiocarb, methomyl, oxamyl, pirimicarb, propoxur, thiodicarb, triazamate;
C. Pyrethroids: allethrin, bifenthrin, cyfluthrin, cyhalothrin, cyphenothrin, cypermethrin, alphacypermethrin, beta-cypermethrin, zeta-cypermethrin, deltamethrin, esfenvalerate, etofenprox, fenpropathrin, fenvalerate, imiprothrin, lambda-cyhalothrin, permethrin, prallethrin, py rethrin I and II, resmethrin, silafluofen, tau-fluvalinate, tefluthrin, tetramethrin, tralomethrin, transfluthrin, profluthrin, dimefluthrin;
D. Insect growth regulators: a) chitin synthesis inhibitors: benzoylureas: chlorfluazuron, cyramazin, diflubenzuron, flucycloxuron, flufenoxuron, hexaflumuron, lufenuron, novaluron, teflubenzuron, triflumuron; buprofezin, diofenolan, hexythiazox, etoxazole, clofentazine; b) ecdysone antagonists: halofenozide, methoxyfenozide, tebufenozide, azadirachtin; c) juvenoids: pyriproxyfen, methoprene, fenoxycarb; d) lipid biosynthesis inhibitors: spirodiclofen, spiromesifen, spirotetramat;
E. Nicotinic receptor agonists/antagonists compounds: clothianidin, dinotefuran, flupyradifurone, imidacloprid, thiamethoxam, nitenpyram, acetamiprid, thiacloprid, 1-(2-chloro-thiazol-5-ylmethyl)-2-nitrimino-3,5-dimethyl-[1,3,5]triazinane; GABA antagonist compounds: endosulfan, ethiprole, fipronil, vaniliprole, pyrafluprole, pyriprole, 5-amino-1-(2,6-dichloro-4-methyl-phenyl)-4-sulfinamoyl-1H-pyrazole-3-carbothioicacid amide;
F. Macrocyclic lactone insecticides: abamectin, emamectin, milbemectin, lepimectin, spinosad, spinetoram;
G. Mitochondrial electron transport inhibitor (METI) I acaricides: fenazaquin, pyridaben, tebufenpyrad, tolfenpyrad, flufenerim;
H. METI II and III compounds: acequinocyl, fluacyprim, hydramethylnon;
I. Uncouplers: chlorfenapyr;
J. Oxidative phosphorylation inhibitors: cyhexatin, diafenthiuron, fenbutatin oxide, propargite;
K. Moulting disruptor compounds: cryomazine;
L. Mixed function oxidase inhibitors: piperonyl butoxide;
M. Sodium channel blockers: indoxacarb, metaflumizone;
N. Others: benclothiaz, bifenazate, cartap, flonicamid, pyridalyl, pymetrozine, sulfur, thiocyclam, flubendiamide, chlorantraniliprole, cyazypyr (HGW86), cyenopyrafen, flupyrazofos, cyflumetofen, amidoflumet, imicyafos, bistrifluron, dinotefuran, and pyrifluquinazon.

In an embodiment of the present invention, the biocide is selected from insecticide, fungicide and mixtures thereof.

In an embodiment of the present invention, the insecticide is at least one pyrethyroid.

In an embodiment of the present invention, the at least one pyrethroid is selected from Bifenthrin, Zeta-cypermethrin, and mixtures thereof.

In an embodiment of the present invention, the fungicide is at least one sterol biosynthesis inhibitor.

In an embodiment of the present invention, the at least one sterol biosynthesis inhibitor is a triazole.

In an embodiment of the present invention, the triazole is Tebuconazole.

Ethoxylated fatty acid alkyl ester of general formula (I)

In an embodiment, the concentrate of the presently claimed invention comprises of the ethoxylated fatty acid alkyl ester.

In an embodiment of the present invention, the ethoxylated fatty acid alkyl ester is a compound of general formula (I)

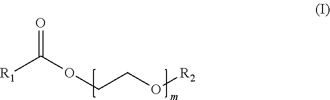

wherein
R₁ is selected from linear or branched, acyclic or cyclic, substituted or unsubstituted C₃ to C₂₀ alkyl or C₃ to C₂₀ alkenyl,
m is an integer in the range of 2 to 30, and
R₂ is selected from linear or branched, acyclic or cyclic, substituted or unsubstituted C₁ to C₁₀ alkyl.

Within the context of the present invention, the term “alkyl”, as used herein, refers to acyclic saturated aliphatic residues, including linear or branched alkyl residues. Furthermore, the alkyl residue is preferably unsubstituted and includes as in the case of C₃-C₂₀ alkyl, 3 to 20 carbon atoms.

Within the context of the present invention, the term “alkenyl”, as used herein, refers to acyclic unsaturated aliphatic residues, including linear or branched alkenyl residues. Furthermore, the alkenyl residue is preferably unsubstituted and includes as in the case of C₃-C₂₀ alkenyl 3 to 20 carbon atoms. Furthermore, unsaturated refers to 1 to 5 double bonds in the carbon chain.

As used herein, “branched” denotes a chain of atoms with one or more side chains attached to it. Branching occurs by the replacement of a substituent, e.g., a hydrogen atom, with a covalently bonded aliphatic moiety.

In an embodiment, R₁ is linear, acyclic, unsubstituted C₃ to C₂₀ alkyl.

Representative examples of linear, acyclic, unsubstituted C₃ to C₂₀ alkyl include, but are not limited to n-propyl, n-butyl, n-pentyl, n-hexyl, n-heptyl, n-octyl, n-nonyl, n-decyl, n-undecyl, n-dodecyl, n-tridecyl, n-tetradecyl, n-pentadecyl, n-hexadecyl, n-heptadecyl, n-octadecyl, n-nonadecyl and n-eicosyl.

In an embodiment, R₁ is linear, acyclic, unsubstituted C₃-C₂₀ alkenyl having 1 to 3 double bonds.

Representative examples of linear, acyclic, unsubstituted C₃ to C₂₀ alkenyl includes, but is not limited to, prop-1-enyl, prop-2-enyl, but-1-enyl, but-2-enyl, but-3-enyl, pent-1-enyl, pent-2-enyl, pent-3-enyl, pent-4-enyl, hex-1-enyl, hex-2-enyl, hex-3-enyl, hex-4-enyl, hex-5-enyl, hept-1-enyl, hept-2-enyl, hept-3-enyl, hept-4-enyl, hept-5-enyl, hept-6-enyl, oct-1-enyl, oct-2-enyl, oct-3-enyl, oct-4-enyl, oct-5-enyl, oct-6-enyl, oct-7-enyl, non-1-enyl, non-2-enyl, non-3-enyl, non-4-enyl, non-5-enyl, non-6-enyl, non-7-enyl, non-8-enyl, dec-1-enyl, dec-2-enyl, dec-3-enyl, dec-4-enyl, dec-5-enyl, dec-6-enyl, dec-7-enyl, dec-8-enyl, dec-9-enyl, undec-1-enyl, undec-2-enyl, undec-3-enyl, undec-4-enyl, undec-5-enyl, undec-6-enyl, undec-7-enyl, undec-8-enyl, undec-9-enyl, undec-10-enyl, dodec-1-enyl, dodec-2-enyl, dodec-3-enyl, dodec-4-enyl, dodec-5-enyl, dodec-6-enyl, dodec-7-enyl, dodec-8-enyl, dodec-9-enyl, dodec-10-enyl, dodec-11-enyl, tridec-1-enyl, tridec-2-enyl, tridec-3-enyl, tridec-4-enyl, tridec-5-enyl, tridec-6-enyl, tridec-7-enyl, tridec-8-enyl, tridec-9-enyl, tridec-10-enyl, tridec-11-enyl, tridec-12-enyl, tetradec-1-enyl, tetradec-2-enyl, tetradec-3-enyl, tetradec-4-enyl, tetradec-5-enyl, tetradec-6-enyl, tetradec-7-enyl, tetradec-8-enyl, tetradec-9-enyl, tetradec-10-enyl, tetradec-11-enyl, tetradec-12-enyl, tetradec-13-enyl, pentadec-1-enyl, pentadec-2-enyl, pentadec-3-enyl, pentadec-4-enyl, pentadec-5-enyl, pentadec-6-enyl, pentadec-7-enyl, pentadec-8-enyl, pentadec-9-enyl, pentadec-10-enyl, pentadec-11-enyl, pentadec-12-enyl, pentadec-13-enyl, pentadec-14-enyl, hexadec-1-enyl, hexadec-2-enyl, hexadec-3-enyl, hexadec-4-enyl, hexadec-5-enyl, hexadec-6-enyl, hexadec-7-enyl, hexadec-8-enyl, hexadec-9-enyl, hexadec-10-enyl, hexadec-11-enyl, hexadec-12-enyl, hexadec-13-enyl, hexadec-14-enyl, hexadec-15-enyl, heptadec-1-enyl, heptadec-2-enyl, heptadec-3-enyl, heptadec-4-enyl, heptadec-5-enyl, heptadec-6-enyl, heptadec-7-enyl, heptadec-8-enyl, heptadec-9-enyl, heptadec-10-enyl, heptadec-11-enyl, heptadec-12-enyl, heptadec-13-enyl, heptadec-14-enyl, heptadec-15-enyl, heptadec-16-enyl, octadec-1-enyl, octadec-2-enyl, octadec-3-enyl, octadec-4-enyl, octadec-5-enyl, octadec-6-enyl, octadec-7-enyl, octadec-8-enyl, octadec-9-enyl, octadec-10-enyl, octadec-11-enyl, octadec-12-enyl, octadec-13-enyl, octadec-14-enyl, octadec-15-enyl, octadec-16-enyl, octadec-17-enyl, nonadec-1-enyl, nonadec-2-enyl, nonadec-3-enyl, nonadec-4-enyl, nonadec-5-enyl, nonadec-6-enyl, nonadec-7-enyl, nonadec-8-enyl, nonadec-9-enyl, nonadec-10-enyl, nonadec-11-enyl, nonadec-12-enyl, nonadec-13-enyl, nonadec-14-enyl, nonadec-15-enyl, nonadec-16-enyl, nonadec-17-enyl, nonadec-18-enyl, icos-1-enyl, icos-2-enyl, icos-3-enyl, icos-4-enyl, icos-5-enyl, icos-6-enyl, icos-7-enyl, icos-8-enyl, icos-9-enyl, icos-10-enyl, icos-11-enyl, icos-12-enyl, icos-13-enyl, icos-14-enyl, icos-15-enyl, icos-16-enyl, icos-17-enyl, icos-18-enyl, icos-19-enyl, heptadeca-8,11-dienyl, heptadeca-8,14-dienyl, heptadeca-11,14-dienyl, heptadeca-8,11,14-trienyl, heptadeca-5,8,11-trienyl, heptadeca-8,10,12-trienyl, heptadeca-8,11,14-trienyl, heptadeca-7,9,11-trienyl, heptadeca-8,11,14-trienyl, heptadeca-5,8,11-trienyl, heptadeca-8,10,12-trienyl, octadeca-9,12-dienyl, octadeca-9,12,15-trienyl, octadeca-6,9,12-trienyl, octadeca-9,11,13-trienyl and octadeca-8,10,12-trienyl, nonadeca-7,10,13-trienyl.

In an another embodiment, the ethoxylated fatty acid alkyl ester of general formula (I), R₁ is selected from n-penyl, n-hexyl, n-heptyl, n-octyl, n-nonyl, n-decyl, n-undecyl, n-dodecyl, n-tridecyl, n-tetradecyl, n-pentadecyl, n-hexadecyl, n-heptadecyl, n-octadecyl, n-nonadecyl, pentadec-8-enyl, heptadec-8-enyl, octadec-9-enyl, heptadeca-8,11-dienyl, heptadeca-8,14-dienyl, heptadeca-11,14-dienyl, heptadeca-8,11,14-trienyl, heptadeca-5,8,11-trienyl, heptadeca-8,10,12-trienyl, octadeca-9,12-dienyl, octadeca-9,12,15-trienyl, octadeca-6,9,12-trienyl, octadeca-9,11,13-trienyl and octadeca-8,10,12-trienyl, nonadeca-7,10,13-trienyl.

In an embodiment of the present invention, m is in the range of 3 to 13, preferably in the range from 4 to 13, or from 5 to 9.

In an embodiment of the present invention, m is in the range of 3 to 13.

In an embodiment of the present invention, m is in the range from 4 to 13.

In an embodiment of the present invention, m is in the range of 4 to 11.

In an embodiment of the present invention, R₂ is linear, acyclic, unsubstituted C₁ to C₁₀ alkyl.

In another embodiment of the present invention, R₂ is selected from methyl, ethyl, n-propyl, n-butyl, n-pentyl, n-hexyl, n-heptyl, n-octyl, n-nonyl and n-decyl.

In yet another embodiment of the present invention, R₂ is methyl.

In an embodiment of the present invention, the at least one ethoxylated fatty acid alkyl ester of general formula (I) has a molecular weight in the range of 100 to 10,000 g/mol, or 200 to 5,000 g/mol, or 300 to 2,500 g/mol, or 300 to 1000 g/mol.

In another embodiment of the present invention, the amount of the at least one ethoxylated fatty acid alkyl ester of general formula (I) is in the range of 80.0% to 99.80% by weight based on the final weight of the concentrate.

In another embodiment of the present invention, the amount of the at least one ethoxylated fatty acid alkyl ester of general formula (I) is in the range of 96.0% to 99.0% by weight based on the final weight of the concentrate.

In an embodiment, the present invention is directed to a stable, solvent-free, self-emulsifiable concentrate consisting of

a. at least one biocide, and

b. at least one ethoxylated fatty acid alkyl ester of general formula (I);

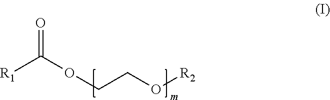

wherein
R₁ is selected from linear or branched, acyclic or cyclic, substituted or unsubstituted C₃ to C₂₀ alkyl or C₃ to C₂₀ alkenyl,
m is an integer in the range of 2 to 30, and
R₂ is selected from linear or branched, acyclic or cyclic, substituted or unsubstituted C₁ to C₁₀ alkyl.

In an embodiment of the present invention, the concentrate comprises:

a. at least one pyrethroid;

b. at least one ethoxylated fatty acid alkyl of general formula (I);

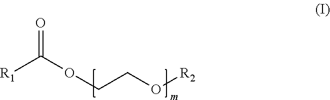

wherein
R₁ is a linear, acyclic, unsubstituted C₃ to C₂₀ alkyl or C₃ to C₂₀ alkenyl,
m is an integer in the range of 3 to 13, and
R₂ is a linear, acyclic, unsubstituted C₁ to C₁₀ alkyl.

In another embodiment of the present invention, the at least one pyrethroid is selected from Bifenthrin, Zeta-cypermethrin, and mixture thereof.

In an embodiment of the present invention, the concentrate comprises

a. at least one sterol biosynthesis inhibitor; and

b. at least one ethoxylated fatty acid alkyl ester of general formula (I)

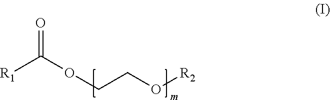

wherein
R₁ is a linear, acyclic, unsubstituted C₃ to C₂₀ alkyl or C₃ to C₂₀ alkenyl,
m is an integer in the range of 3 to 13, and
R₂ is a linear, acyclic, unsubstituted C₁ to C₁₀ alkyl.

In another embodiment of the present invention, the at least one sterol biosynthesis inhibitor is a triazole.

In yet another embodiment of the present invention, the triazole is Tebuconazole.

Depending on the application method in question, the concentrate according to the invention can additionally be employed in a further number of crop plants for eliminating undesirable plants. Examples of suitable crops are the following: Allium cepa, Ananas comosus, Arachis hypogaea, Asparagus officinalis, Avena sativa, Beta vulgaris spec. altissima, Beta vulgaris spec. rapa, Brassica napus var. napus, Brassica napus var. napobrassica, Brassica rapa var. silvestris, Brassica oleracea, Brassica nigra, Brassica juncea, Brassica campestris, Camellia sinensis, Carthamus tinctorius, Carya illinoinensis, Citrus limon, Citrus sinensis, Coffea arabica (Coffea canephora, Coffea liberica), Cucumis sativus, Cynodon dactylon, Daucus carota, Elaeis guineensis, Fragaria vesca, Glycine max, Gossypium hirsutum, (Gossypium arboreum, Gossypium herbaceum, Gossypium vitifolium), Helianthus annuus, Hevea brasiliensis, Hordeum vulgare, Humulus lupulus, Ipomoea batatas, Juglans regia, Lens culinaris, Linum usitatissimum, Lycopersicon lycopersicum, Malus spec., Manihotes-culenta, Medicago sativa, Musa spec., Nicotiana tabacum (N. rustica), Olea europaea, Oryza sativa, Phaseolus lunatus, Phaseolus vulgaris, Picea abies, Pinus spec., Pistacia vera, Pisum sativum, Prunus avium, Prunus persica, Pyrus communis, Prunus armeniaca, Prunus cerasus, Prunus dulcis and prunus domestica, Ribes sylvestre, Ricinus communis, Saccharum officinarum, Secale cereale, Sinapis alba, Solanum tuberosum, Sorghum bicolor (s. vulgare), Theobroma cacao, Trifolium pratense, Triticum aestivum, Triticale, Triticum durum, Vicia faba, Vitis vinifera, Zea mays.

In an embodiment of the present invention, the crops are Arachis hypogaea, Beta vulgaris spec. altissima, Brassica napus var. napus, Brassica oleracea, Brassica juncea, Citrus limon, Citrus sinensis, Coffea arabica (Coffea canephora, Coffea liberica), Cynodon dactylon, Glycine max, Gossypium hirsutum, (Gossypium arboreum, Gossypium herbaceum, Gossypium vitifolium), Helianthus annuus, Hordeum vulgare, Juglans regia, Lens culinaris, Linum usitatissimum, Lycopersicon lycopersicum, Malus spec., Medicago sativa, Nicotiana tabacum (N. rustica), Olea europaea, Oryza sativa, Phaseolus lunatus, Phaseolus vulgaris, Pistacia vera, Pisum sativum, Prunus dulcis, Saccharum officinarum, Secale cereale, Solanum tuberosum, Sorghum bicolor (s. vulgare), Triticale, Triticum aestivum, Triticum durum, Vicia faba, Vitis vinifera and Zea mays

In an embodiment of the present invention, the concentrate according to the invention can also be used in genetically modified plants, e.g. to alter their traits or characteristics. The term “genetically modified plants” is to be understood as plants, which genetic material has been modified by the use of recombinant DNA techniques in a way that under natural circumstances it cannot readily be obtained by cross breeding, mutations, natural recombination, breeding, mutagenesis, or genetic engineering. Typically, one or more genes have been integrated into the genetic material of a genetically modified plant in order to improve certain properties of the plant. Such genetic modifications also include but are not limited to targeted post-transitional modification of protein(s), oligo- or polypeptides e. g. by glycosylation or polymer additions such as prenylated, acetylated or famesylated moieties or PEG moieties.

In an embodiment of the present invention, the plants that have been modified by breeding, mutagenesis or genetic engineering, e.g. have been rendered tolerant to applications of specific classes of herbicides, are particularly useful with the concentrate according to the invention. Tolerance to classes of herbicides has been developed such as auxin herbicides such as dicamba or 2,4-D; bleacher herbicides such as hydroxyphenylpyruvate dioxygenase (HPPD) inhibitors or phytoene desaturase (PDS) inhibitors; acetolactate synthase (ALS) inhibitors such as sulfonyl ureas or imidazolinones; enolpyruvyl shikimate 3-phosphate synthase (EPSP) inhibitors such as glyphosate; glutamine synthetase (GS) inhibitors such as glufosinate; protoporphyrinogen-IX oxidase (PPO) inhibitors; lipid biosynthesis inhibitors such as acetyl CoA carboxylase (ACCase) inhibitors; or oxynil (i. e. bromoxynil or ioxynil) herbicides as a result of conventional methods of breeding or genetic engineering. Furthermore, plants have been made resistant to multiple classes of herbicides through multiple genetic modifications, such as resistance to both glyphosate and glufosinate or to both glyphosate and an herbicide from another class such as ALS inhibitors, HPPD inhibitors, auxin herbicides, or ACCase inhibitors. These herbicide resistance technologies are, for example, described in Pest Management Science 61, 2005, 246; 61, 2005, 258; 61, 2005, 277; 61, 2005, 269; 61, 2005, 286; 64, 2008, 326; 64, 2008, 332; Weed Science 57, 2009, 108; Australian Journal of Agricultural Research 58, 2007, 708; Science 316, 2007, 1185; and references quoted therein. Examples of these herbicide resistance technologies are also described in US 2008/0028482, US2009/0029891, WO 2007/143690, WO 2010/080829, U.S. Pat. Nos. 6,307,129, 7,022,896, US 2008/0015110, U.S. Pat. Nos. 7,632,985, 7,105,724, and 7,381,861, each herein incorporated by reference.

In an embodiment of the present invention, the plants that are cultivated by the use of recombinant DNA techniques capable to synthesize one or more insecticidal proteins, especially those known from the bacterial genus Bacillus, particularly from Bacillus thuringiensis, such as a-endotoxins, e. g. CryIA(b), CryIA(c), CryIF, CryIF(a2), CryIIA(b), CryIIIA, CryIIIB(b1) or Cry9c; vegetative insecticidal proteins (VIP), e. g. VIP1, VIP2, VIP3 or VIP3A; insecticidal proteins of bacteria colonizing nematodes, e. g. Photorhabdus spp. or Xenorhabdus spp.; toxins produced by animals, such as scorpion toxins, arachnid toxins, wasp toxins, or other insect-specific neurotoxins; toxins produced by fungi, such Streptomycetes toxins, plant lectins, such as pea or barley lectins; agglutinins; proteinase inhibitors, such as trypsin inhibitors, serine protease inhibitors, patatin, cystatin or papain inhibitors; ribosome-inactivating proteins (RIP), such as ricin, maize-RIP, abrin, luffin, saporin or bryodin; steroid metabolism enzymes, such as 3-hydroxy-steroid oxidase, ecdysteroid-IDP-glycosyl-transferase, cholesterol oxidases, ecdysone inhibitors or HMG-CoA-reductase; ion channel blockers, such as blockers of sodium or calcium channels; juvenile hormone esterase; diuretic hormone receptors (helicokinin receptors); stilben synthase, bibenzyl synthase, chitinases or glucanases. In the context of the present invention these insecticidal proteins or toxins are to be under-stood expressly also as pre-toxins, hybrid proteins, truncated or otherwise modified proteins. Hybrid proteins are characterized by a new combination of protein domains, (see, e. g. WO 02/015701). Further examples of such toxins or genetically modified plants capable of synthesizing such toxins are dis-closed, e. g., in EP-A 374 753, WO 93/007278, WO 95/34656, EP-A 427 529, EP-A 451 878, WO 03/18810 and WO 03/52073. The methods for producing such genetically modified plants are generally known to the person skilled in the art and are described, e. g. in the publications mentioned above. These insecticidal proteins contained in the genetically modified plants impart to the plants producing these proteins tolerance to harmful pests from all taxonomic groups of arthropods, especially to beetles (Coeloptera), two-winged insects (Diptera), and moths (Lepidoptera) and to nematodes (Nematoda). Genetically modified plants capable to synthesize one or more insecticidal proteins are, e. g., described in the publications mentioned above, and some of which are commercially available such as YieldGard® (corn cultivars producing the Cry1Ab toxin), YieldGard® Plus (corn cultivars producing Cry1Ab and Cry3Bb1 toxins), Starlink® (corn cultivars producing the Cry9c toxin), Herculex® RW (corn cultivars producing Cry34Ab1, Cry35Ab1 and the enzyme Phosphinothricin-N-Acetyltransferase [PAT]); NuCOTN® 33B (cotton cultivars producing the Cry1Ac toxin), Bollgard® I (cotton cultivars producing the Cry1Ac toxin), Bollgard® II (cotton cultivars producing Cry1Ac and Cry2Ab2 toxins); VIPCOT® (cotton cultivars producing a VIP-toxin); NewLeaf® (potato cultivars producing the Cry3A toxin); Bt-Xtra®, NatureGard®, Knock-Out®, BiteGard®, Protecta®, Btl1 (e. g. Agrisure® CB) and Bt176 from Syngenta Seeds SAS, France, (corn cultivars producing the Cry1Ab toxin and PAT enzyme), MIR604 from Syngenta Seeds SAS, France (corn cultivars producing a modified version of the Cry3A toxin, c.f. WO 03/018810), MON 863 from Monsanto Europe S.A., Belgium (corn cultivars producing the Cry3Bb1 toxin), IPC 531 from Monsanto Europe S.A., Belgium (cotton cultivars producing a modified version of the Cry1Ac toxin) and 1507 from Pioneer Overseas Corporation, Belgium (corn cultivars producing the CryiF toxin and PAT enzyme).

In an embodiment of the present invention, the plants are also covered that are capable to synthesize one or more proteins to increase the resistance or tolerance of those plants to bacterial, viral or fungal pathogens by the use of recombinant DNA techniques. Examples of such proteins are the so-called “pathogenesis-related proteins” (PR proteins, see, e.g. EP-A 392 225), plant disease resistance genes (e. g. potato cultivars, which express resistance genes acting against Phytophthora infestans derived from the mexican wild potato Solanum bulbocastanum) or T4-lyso-zym (e.g. potato cultivars capable of synthesizing these proteins with increased resistance against bacteria such as Erwinia amylvora). The methods for producing such genetically modified plants are generally known to the person skilled in the art and are described, e.g. in the publications mentioned above.

In a further embodiment of the present invention, those plants are also covered that contain by the use of recombinant DNA techniques a modified amount of substances of content or new substances of content, specifically to improve human or animal nutrition, e. g. oil crops that produce health-promoting long-chain omega-3 fatty acids or unsaturated omega-9 fatty acid. Those plants are also covered that contain by the use of recombinant DNA techniques a modified amount of substances of content or new substances of content, specifically to improve raw material production, e.g. potatoes that produce increased amounts of amylopectin.

Another aspect of the present invention is directed to a method of forming a stable, solvent-free, self-emulsifiable concentrate as defined above. The method comprises the step of mixing the at least one biocide with the at least one ethoxylated fatty acid alkyl ester of general formula (I). The aforementioned components and compounds may be added in any order to one or more of each other and in any amount and in one or more individual steps, e.g. in whole or in parts.

In an embodiment of the present invention, the at least one biocide is dissolved in the at least one ethoxylated fatty acid alkyl ester of general formula (I) by stirring.

In another embodiment of the present invention, the at least one biocide is dissolved in the at least one ethoxylated fatty acid alkyl ester of general formula (I) by stirring and heating.

In an embodiment, by the method of the present invention, emulsifiable concentrate (EC) of the at least one biocide in the at least one ethoxylated fatty acid alkyl ester of general formula (I), is obtained, when the inventive concentrate is added to water.

An emulsifiable concentrate (EC) is taken to mean concentrate which forms an oil-in-water emulsion upon mixing with water (e.g. in a weight ratio of 1-part concentrate to 99-parts water). The concentrate is preferably a homogeneous solution. It is usually virtually free of dispersed particles.

In an embodiment of the present invention, the concentrate is stable.

In an embodiment of the present invention, the concentrate is stable for at least 24 hours at room temperature.

In an embodiment of the present invention, the concentrate when resuspended after 24 hours, is stable for 30 minutes.

The stability of the concentrate is accessed by the formation of cream or oil.

The aforementioned components and compounds may be added in any order to one or more of each other and in any amount and in one or more individual steps, e.g. in whole or in parts.

In a preferred embodiment, the at least one biocide and the at least one ethoxylated fatty acid alkyl ester of general formula (I) according to the invention may be mixed in a spray tank.

The concentrate according to the presently claimed invention can be applied from a pre-dosage device, a knapsack sprayer, a spray tank, a spray plane, or an irrigation system.

Another aspect of the present invention is directed to use of the concentrate as defined above for the treatment of an agricultural target. In an embodiment of the present invention, the agricultural target may be any known in the art of biocide applications and may be for examples, crops, fields, plants, etc.

In an embodiment, the concentrate of the presently claimed invention can easily be diluted with water, e.g. prior to application with large amounts of water, e.g. from 5 to 10 000 parts of water per 1 part of the formulation, in particular from 10 to 5 000 parts of water per 1 part of the formulation, without the formation of coarse material and the aqueous dilutions have enhanced physical stability, i.e. the formation of solids after dilution is not observed even after storage for a prolonged period of time, e.g. after 24 h at room temperature no crystallization is observed. The quality of water used for dilution does not play a significant role; e.g. tap water as well as well water can be used.

The invention furthermore relates to a method for controlling phytopathogenic fungi and insects, where the concentrate according to the invention or the resulting emulsifiable concentrate (EC) according to the invention is allowed to act on the phytopathogenic fungi or insects, their environment, on the crop plants to be protected from the phytopathogenic fungi and insects or on the soil. The therapeutic treatment of humans and animals is excluded from the method for controlling phytopathogenic fungi.

In another embodiment of the present invention, when employed in crop protection, the application rates of the concentrate of the presently claimed invention amount to from 0.001 to 2 kg per ha, preferably from 0.005 to 2 kg per ha, especially preferably from 0.05 to 0.9 kg per ha and in particular from 0.1 to 0.75 kg per ha, depending on the nature of the desired effect. In treatment of plant propagation materials such as seeds, e. g. by dusting, coating or drenching seed, amounts of active substance of from 0.1 to 1000 g, preferably from 1 to 1000 g, more preferably from 1 to 100 g and most preferably from 5 to 100 g, per 100 kg of plant propagation material (preferably seed) are generally required. When used in the protection of materials or stored products, the amount of active substance applied depends on the kind of application area and on the desired effect. Amounts customarily applied in the protection of materials are 0.001 g to 2 kg, preferably 0.005 g to 1 kg, of active substance per cubic meter of treated material.

In another embodiment of the present invention, the agricultural target is soil and plants.

Another aspect of the present invention is directed to a kit for preparing the concentrate as defined above comprising, as separate components, (a) the at least one biocide, and (b) the at least one ethoxylated fatty acid alkyl ester of general formula (I).

In an embodiment, the concentrate of the presently claimed invention is free of additional surfactants and emulsifiers.

The concentrate of the present invention offers one or more of following advantages:

1. The concentrate is solvent free, i.e. does not require additional solvent.
2. The concentrate is self emulsifiable.
3. The concentrate does not require addition of inerts to provide solvency and emulsification.
4. The concentrate is stable for longer periods and hence can be stored without any phase separation.

### Embodiments

The present invention is illustrated in more detail by the following embodiments and combinations of embodiments which result from the corresponding dependency references and links:

1. A stable, solvent-free, self-emulsifiable concentrate comprising

c. at least one biocide, and

d. at least one ethoxylated fatty acid alkyl ester of general formula (I);

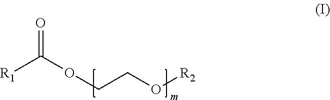

wherein
R₁ is selected from linear or branched, acyclic or cyclic, substituted or unsubstituted C₃ to C₂₀ alkyl or C₃ to C₂₀ alkenyl,
m is an integer in the range of 2 to 30, and
R₂ is selected from linear or branched, acyclic or cyclic, substituted or unsubstituted C₁ to C₁₀ alkyl.
   2. The concentrate according to embodiment 1, wherein the at least one biocide is a pesticide selected from herbicide, insecticide and fungicide.
   3. The concentrate according to embodiment 2, wherein the herbicide is selected from acetamides, amino acid derivatives, aryloxyphenoxypropionates, bipyridyls, (thio)carbamates, cyclohexanediones, dinitroanilines, diphenyl ethers, hydroxybenzonitriles, imidazolinones, phenoxy acetic acids, pyrazines, pyridines, sulfonylureas, triazines, ureas, pyrimidinedione, acetolactate synthase inhibitors, and mixtures thereof.
   4. The concentrate according to embodiment 2, wherein the insecticide is selected from organo (thio)phosphates, carbamates, pyrethroids, insect growth regulators, nicotinic receptor agonists/antagonists, macrocyclic lactones, mitochondrial electron transport inhibitors, oxidative phosphorylation inhibitors, moulting disruptor compounds, mixed function oxidase inhibitors, and mixtures thereof.
   5. The concentrate according to embodiment 2, wherein the fungicide is selected from respiration inhibitors, sterol biosynthesis inhibitors, nucleic acid synthesis inhibitors, inhibitors of cell division and cytoskeleton, inhibitors of amino acid and protein synthesis, signal transduction inhibitors, protein inhibitors, lipid and membrane synthesis inhibitors, inhibitors with multi-site action, cell wall synthesis inhibitors, plant defense inducers, and mixtures thereof.
   6. The concentrate according to embodiment 1, wherein R₁ is a linear, acyclic, unsubstituted C3 to C20 alkyl or linear, acyclic, unsubstituted C3 to C20 alkenyl.
   7. The concentrate according to one or more of embodiment 1 to 6, wherein R₁ is selected from n-propyl, n-butyl, n-pentyl, n-hexyl, n-heptyl, n-octyl, n-nonyl, n-decyl, n-undecyl, n-dodecyl, n-tridecyl, n-tetradecyl, n-pentadecyl, n-hexadecyl, n-heptadecyl, n-octadecyl, n-nonadecyl, n-eicosyl, pentadec-8-enyl, heptadec-8-enyl, octadec-9-enyl, heptadeca-8,11-dienyl, heptadeca-8,14-dienyl, heptadeca-11,14-dienyl, heptadeca-8,11,14-trienyl, heptadeca-5,8,11-trienyl, heptadeca-8,10,12-trienyl, octadeca-9,12-dienyl, octadeca-9,12,15-trienyl, octadeca-6,9,12-trienyl, octadeca-9,11,13-trienyl and octadeca-8,10,12-trienyl, nonadeca-7,10,13-trienyl.
   8. The concentrate according to one or more of embodiment 1 to 7, wherein R₁ is selected from n-butyl, n-pentyl, n-hexyl, n-heptyl, n-octyl, n-nonyl, n-decyl, n-undecyl, n-dodecyl, n-tridecyl, n-tetradecyl, n-pentadecyl, n-hexadecyl, n-heptadecyl, n-octadecyl, pentadec-8-enyl, heptadec-8-enyl, octadec-9-enyl, heptadeca-8,11-dienyl, heptadeca-8,14-dienyl, heptadeca-11,14-dienyl, heptadeca-8,11,14-trienyl, heptadeca-5,8,11-trienyl, heptadeca-8,10,12-trienyl, octadeca-9,12-dienyl, octadeca-9,12,15-trienyl, octadeca-6,9,12-trienyl, octadeca-9,11,13-trienyl and octadeca-8,10,12-trienyl, nonadeca-7,10,13-trienyl.
   9. The concentrate according to embodiment 1, wherein m is in the range of 3 to 13.
   10. The concentrate according to embodiment 1, wherein R₂ is a linear, acyclic, unsubstituted C1 to C10 alkyl.
   11. The concentrate according to one or more of embodiment 1 to 10, wherein R₂ is selected from methyl, ethyl, n-propyl, n-butyl, n-pentyl, n-hexyl, n-heptyl, n-octyl, n-nonyl and n-decyl.
   12. The concentrate according to one or more of embodiment 1 to 11, wherein R₂ is methyl.
   13. The concentrate according to one or more of embodiment 1 to 11, wherein the amount of the at least one biocide is in the range of 0.20 to 20%, by weight based on the final weight of the concentrate.
   14. The concentrate according to one or more of embodiment 1 to 11, wherein the amount of the at least one ethoxylated fatty acid alkyl ester of general formula (I); is in the range of 80.0 to 99.80%, by weight based on the final weight of the concentrate.
   15. The concentrate according to one or more of embodiment 1 to 14 comprising

a. at least one pyrethroid; and

b. at least one ethoxylated fatty acid alkyl ester of general formula (I);

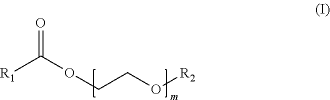

wherein
R₁ is a linear, acyclic, unsubstituted C₃ to C₂₀ alkyl or C₃ to C₂₀ alkenyl,
m is an integer in the range of 3 to 13, and
R₂ is a linear, acyclic, unsubstituted C₁ to C₁₀ alkyl.
   16. The concentrate according to embodiment 15, wherein the at least one pyrethroid is selected from Bifenthrin, Zeta-cypermethrin, and mixtures thereof.
   17. The concentrate according to one or more of embodiments 1 to 14 comprising

a. at least one sterol biosynthesis inhibitor; and

b. at least one ethoxylated fatty acid alkyl ester of general formula (I);

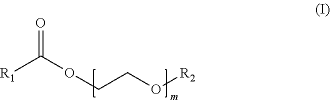

wherein
R₁ is a linear, acyclic, unsubstituted C₃ to C₂₀ alkyl or C₃ to C₂₀ alkenyl,
m is an integer in the range of 3 to 13, and
R₂ is a linear, acyclic, unsubstituted C₁ to C₁₀ alkyl.
   18. The concentrate according to embodiment 17, wherein the at least one sterol biosynthesis inhibitor is a triazole.
   19. The concentrate according to embodiment 18, wherein the triazole is Tebuconazole.
   20. A method of forming a stable, solvent-free, self-emulsifiable concentrate according to one or more of embodiment 1 to 19, the method comprising the step of mixing the at least one biocide with the at least one ethoxylated fatty acid alkyl ester of general formula (I).
   21. Use of the concentrate according to one or more of embodiment 1 to 19 for the treatment of soil and plants, lawns and gardens, and buildings and other surfaces and structures where pests reside.
   22. A kit for preparing the concentrate according to one or more of embodiment 1 to 19 comprising, as separate components, (a) the at least one biocide, and (b) the at least one ethoxylated fatty acid alkyl ester of general formula (I).

### Examples

The present invention is further illustrated in combination with the following examples. These examples are provided to exemplify the present invention but are not intended to restrict the scope of the presently claimed invention in any way. More particularly, the test methods specified hereinafter are part of the general disclosure of the application and are not restricted to the specific working examples. The terms and abbreviations in the examples have their common meanings. For example, “ppm”, “g”, “%”, “% NCO”, “Eq. wt.”, “Eq.”, “° C.”, “wt. %”, “% w/w”, “% w/v” and “gm” represent “parts per million”, “gram”, “percentage”, “isocyanate content/percent Nitrogen Carbon Oxygen”, “Equivalent Weight”, “Equivalents”, “degree Celsius”, “percent by weight”, “percent weight by weight”, “percent weight by volume” and “gram” respectively.

Materials

COMPOUNDS

| | |
|---|---|
| Bifenthrin | Pyrethroid, CAS No. 82657-04-3, IUPAC Name: |
| | 2-Methyl-3-phenylphenyl)methyl (1S,3S)-3-[(Z)-2-chloro- |
| | 3,3,3-trifluoroprop-1-enyl]- 2,2-dimethylcyclopropane-1- |
| | carboxylate |
| Zeta-Cypermethrin | Pyrethroid, CAS No. 97955-44-7, IUPAC Name: |
| | Mixture of the stereoisomers (S)-α-cyano-3-phenoxybenzyl |
| | (1RS,3RS;1RS,3SR)-3-(2,2-dichlorovinyl)-2,2- |
| | dimethylcyclopropanecarboxylate where the ratio of the |
| | (S);(1RS,3RS) isomeric pair to the (S);(1RS,3SR) isomeric |
| | pair lies in the ratio range 45-55 to 55-45 respectively |
| Tebuconazole | Triazole, Sterol biosynthesis inhibitor, |
| | IUPAC Name: (RS)-1-(4-Chlorophenyl)-4,4-dimethyl-3- |
| | (1H,1,2,4-triazol-1-ylmethyl)pentan-3-ol |
| Ethoxylated fatty acid alkyl | R₁ = C₈-C₁₈ alkyl and C₈-C₁₈ alkenyl, |
| ester of general Formula I | R₂ = C₁ alkyl, m = 3-8. |
| Bio Advanced | 2.90% Tebuconazole and 97.10% inerts |
| Comparative Compound | other than compound of Formula (I) |
| details | |

Example 1 (E1): Concentrate comprises of 1% Bifenthrin (0.25 g) dissolved in 98.75% ethoxylated fatty acid alkyl ester of general formula I (24.69 g) with heating/stirring then 0.25% Zeta-Cypermethrin (0.06 g) was added and stirred to give a clear solution.

Example 2 (E2): Concentrate comprises of 2.90% Tebuconazole (1.46 g) is dissolved in 97.1% (48.56 g) Compound of Formula I with heating and stirring to give a clear solution.

Comparative Example 1 (CE1): Concentrate comprises of Comparative Example 1 (CE1) was prepared with Bio-advanced (2.90% Tebuconazole) EC.

The formulation of Examples is provided in Table 1 below:

TABLE 1

| | E1 | | E2 | | CE 1 | |
|---|---|---|---|---|---|---|
| | % | Wt., | % | Wt., | % | Wt., |
| Compounds | weight | g | weight | g | weight | g |
| Bifenthrin | 1% | 0.25 | — | — | — | — |
| Compound of | 98.75% | 24.69 | 97.10% | 48.56 | — | — |
| Formula 1 | | | | | | |
| Zeta-Cypermethrin | 0.25% | 0.06 | — | — | — | — |
| Tebuconazole | — | — | 2.90% | 1.46 | 2.90% | 1.46 |
| Inerts other than | — | — | — | — | 97.10% | 48.56 |
| compound of | | | | | | |
| formula (I) | | | | | | |
| Physical | Clear | — | Clear | — | — | Thick |
| Properties/ | Solution | | Solution | | | white |
| Appearance | | | | | | fluid |

Analytical Methods

Measurement of Stability of the Concentrates

The procedure describes the process engaged to determine the stability of the Examples 1 and 2 based on the concentrate as presently disclosed as well as the comparative formulation of the Comparative Example 1. The concentrates were used in various dilutions to form 100 mL solution with H₂O/water. For diluting a solution, 5 mL, 2 mL and 0.6 mL of the emulsifiable concentrate was added with 95 mL, 98 mL and 99.4 mL of water respectively to form 100 mL solution. For instance, pipetted (graduated) 5 mL (0.050%) Bifenthrin+(0.0125%) Zeta-Cypermethrin, (i.e. Solution of E1) into 95 mL 34, 342 & 500 ppm waters in a 100 mL glass cylinder with rubber stopper to give an oil in water emulsion. The solution is observed for separation and settling after 2, 4, and 24 hrs. After 24 hrs the solution is resuspended by inversion 10 times and observed 30 minutes after resuspension for separation and settling. Disposable syringe was used for smaller dilutions of 0.6 ml.

These dilutions were kept on shelf for different time periods of 2 hours, 4 hours, 24 hours and in re-inverted (10×) form for 0.5 hours/30 mins. The dilutions were observed checked for formation of cream or oil. Below Table 2, 3 and 4 provide result of the observations made on formation of cream or oil in 34 ppm, 342 ppm and 500 ppm water hardness, respectively.

TABLE 2
Emulsion stability in 34 ppm hard water

| | Examples | | | | | | |
|---|---|---|---|---|---|---|---|
| | E1 | E2 | E2 | E2 | CE1 | CE1 | CE1 |
| | Dilution | | | | | | |
| | 5 mL into | 5 mL into | 2 mL into | 0.6 mL into | 5 mL into | 2 mL into | 0.6 mL into |
| vs. Time | 95 mL water | 95 mL water | 98 mL water | 99.4 mL water | 95 mL water | 98 mL water | 99.4 mL water |
| 2 hrs | no | no | no | 0.6 mL | 1 mL | 1 mL | no |
| | oil/cream | oil/cream | oil/cream | oil | cream | cream | oil/cream |
| 4 hrs | no | 0.7 mL | 0.6 mL | 0.6 mL | 2.5 mL | 2 mL | 0.6 mL |
| | oil/cream | oil | oil | oil | cream | cream | cream |
| 24 hrs | no | 0.7 mL | 0.6 mL | 0.6 mL | 3 mL | 2 mL | 0.6 mL |
| | oil/cr | oil | oil | oil | cream | cream | cream |
| | | | | | (yellow) | (yellow) | |
| reinverted | no | no | no | no | 0.6 mL | 0.1 mL | no |
| 30 mins | oil/cream | oil/cream | oil | oil/cream | cream/oil | cream/oil | oil/cream |
| | | | | | (yellow) | (yellow) | |

TABLE 3
Emulsion stability in 342 ppm hard water

| | Examples | | | | | | |
|---|---|---|---|---|---|---|---|
| | E1 | E2 | E2 | E2 | CE1 | CE1 | CE1 |
| | Dilution | | | | | | |
| | 5 mL into | 5 mL into | 2 mL into | 0.6 mL into | 5 mL into | 2 mL into | 0.6 mL into |
| vs. Time | 95 mL water | 95 mL water | 98 mL water | 99.4 mL water | 95 mL water | 98 mL water | 99.4 mL water |
| 2 hrs | no | no | no | no | 1 mL | 1.2 mL | no |
| | oil/cream | oil/cream | oil/cream | oil/cream | cream | cream | oil/cream |
| 4 hrs | no | 0.7 mL | 0.5 mL | no | 2 mL | 3 mL | no |
| | oil/cream | oil | oil | oil/cream | cream | cream | oil/cream |
| 24 hrs | no | 0.7 mL | 1 mL | 0.4 mL | 2.7 mL | 2.5 mL | 0.4 mL |
| | oil/cream | oil | oil | oil | cream | cream | cream |
| | | | | | (yellow) | (yellow) | |
| reinverted | no | no | no | no | 0.8 mL | 0.7 mL | no |
| 30 mins | oil/cream | oil/cream | oil/cream | oil/cream | cream/oil | cream/oil | oil/cream |
| | | | | | (yellow) | (yellow) | |

TABLE 4
Emulsion stability in 500 ppm hard water

| | Examples | | | | | | |
|---|---|---|---|---|---|---|---|
| | E1 | E2 | E2 | E2 | CE1 | CE1 | CE1 |
| | Dilution | | | | | | |
| | 5 mL into | 5 mL into | 2 mL into | 0.6 mL into | 5 mL into | 2 mL into | 0.6 mL into |
| vs. Time | 95 mL water | 95 mL water | 98 mL water | 99.4 mL water | 95 mL water | 98 mL water | 99.4 mL water |
| 2 hrs | no | no | no | no | 1.2 mL | 1 mL | no |
| | oil/cream | oil/cream | oil/cream | oil/cream | cream | cream | oil/cream |
| 4 hrs | no | 0.7 mL | 0.6 mL | no | 2.8 mL | 2 mL | no |
| | oil/cream | oil | oil | oil/cream | cream | cream | oil/cream |
| 24 hrs | no | 0.7 mL | 0.7 mL | 0.4 mL | 3.2 mL | 2 mL | 0.4 mL |
| | oil/cream | oil | oil | oil | cream | cream | cream |
| | | | | | (yellow) | (yellow) | |
| reinverted | no | no | no | no | 1.1 mL | 0.6 mL | no |
| 30 mins | oil/cream | oil/cream | oil/cream | oil/cream | cream/oil | cream/oil | oil/cream |
| | | | | | (yellow) | (yellow) | |

Table 2, 3 and 4 depict that across different dilutions and across different time periods, the concentrate as presently disclosed is associated with significantly improved emulsion stability. Almost no oil or cream formation is observed at different dilutions of the Examples.

The stability at different dilutions depicted in Table 2, 3 and 4 as well as the concentrate formulated as per Table 1 denote that the concentrate is used for preparation of solution without any additional solvent.

The two-component formulation thus acts as solvent and emulsifier simultaneously. Therefore, there is no need for other inerts to provide solvency and emulsification

1. A stable, solvent-free, self-emulsifiable concentrate comprising
a. at least one biocide, and
b. at least one ethoxylated fatty acid alkyl ester of general formula (I); 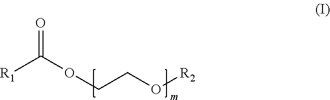
wherein
R₁ is selected from the group consisting of linear or branched, acyclic or cyclic, substituted or unsubstituted C₃ to C₂₀ alkyl or C₃ to C₂₀ alkenyl,
m is an integer in the range of 2 to 30, and
R₂ is selected from the group consisting of linear or branched, acyclic or cyclic, substituted or unsubstituted C₁ to C₁₀ alkyl.

2. The concentrate according to claim 1, wherein the at least one biocide is a pesticide selected from the group consisting of herbicide, insecticide and fungicide.

3. The concentrate according to claim 2, wherein the herbicide is selected from the group consisting of acetamides, amino acid derivatives, aryloxyphenoxypropionates, bipyridyls, (thio)carbamates, cyclohexanediones, dinitroanilines, diphenyl ethers, hydroxybenzonitriles, imidazolinones, phenoxy acetic acids, pyrazines, pyridines, sulfonylureas, triazines, ureas, pyrimidinedione, acetolactate synthase inhibitors, and mixtures thereof.

4. The concentrate according to claim 2, wherein the insecticide selected from the group consisting of organo (thio)phosphates, carbamates, pyrethroids, insect growth regulators, nicotinic receptor agonists/antagonists, macrocyclic lactones, mitochondrial electron transport inhibitors, oxidative phosphorylation inhibitors, moulting disruptor compounds, mixed function oxidase inhibitors, and mixtures thereof.

5. The concentrate according to claim 2, wherein the fungicide is selected from the group consisting of respiration inhibitors, sterol biosynthesis inhibitors, nucleic acid synthesis inhibitors, inhibitors of cell division and cytoskeleton, inhibitors of amino acid and protein synthesis, signal transduction inhibitors, protein inhibitors, lipid and membrane synthesis inhibitors, inhibitors with multi-site action, cell wall synthesis inhibitors, plant defense inducers, and mixtures thereof.

6. The concentrate according to claim 1, wherein R₁ is a linear, acyclic, unsubstituted C₃ to C₂₀ alkyl or C₃ to C₂₀ alkenyl.

7. The concentrate according to claim 1, wherein R₁ is selected from the group consisting of n-butyl, n-pentyl, n-hexyl, n-heptyl, n-octyl, n-nonyl, n-decyl, n-undecyl, n-dodecyl, n-tridecyl, n-tetradecyl, n-pentadecyl, n-hexadecyl, n-heptadecyl, n-octadecyl, pentadec-8-enyl, heptadec-8-enyl, octadec-9-enyl, heptadeca-8,11-dienyl, heptadeca-8,14-dienyl, heptadeca-11,14-dienyl, heptadeca-8,11,14-trienyl, heptadeca-5,8,11-trienyl, heptadeca-8,10,12-trienyl, octadeca-9,12-dienyl, octadeca-9,12,15-trienyl, octadeca-6,9,12-trienyl, octadeca-9,11,13-trienyl and octadeca-8,10,12-trienyl, and nonadeca-7,10,13-trienyl.

8. The concentrate according to claim 1, wherein m is in the range of 3 to 13.

9. The concentrate according to claim 1, wherein R₂ is a linear, acyclic, unsubstituted C₁ to C₁₀ alkyl.

10. The concentrate according to claim 1, wherein R₂ is selected from the group consisting of methyl, ethyl, n-propyl, n-butyl, n-pentyl, n-hexyl, n-heptyl, n-octyl, n-nonyl and n-decyl.

11. The concentrate according to claim 1, wherein R₂ is methyl.

12. The concentrate according to claim 1, wherein the amount of the at least one biocide is in the range of 0.20 to 20%, by weight based on the final weight of the concentrate.

13. The concentrate according to claim 1, wherein the amount of the at least one ethoxylated fatty acid alkyl ester of general formula (I); is in the range of 80.0 to 99.80%, by weight based on the final weight of the concentrate.

14. The concentrate according to claim 1 comprising
a. at least one pyrethroid; and
b. at least one ethoxylated fatty acid alkyl ester of general formula (I); 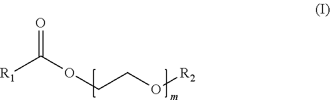
wherein
R₁ is a linear, acyclic, unsubstituted C₃ to C₂₀ alkyl or C₃ to C₂₀ alkenyl,
m is an integer in the range of 3 to 13, and
R₂ is a linear, acyclic, unsubstituted C₁ to C₁₀ alkyl.

15. The concentrate according to claim 14, wherein the at least one pyrethroid is selected from the group consisting of Bifenthrin, Zeta-cypermethrin, and mixtures thereof.

16. The concentrate according to claim 1 comprising
a. at least one sterol biosynthesis inhibitor; and
b. at least one ethoxylated fatty acid alkyl ester of general formula (I); 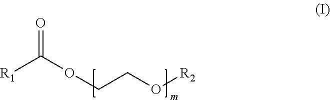
wherein
R₁ is a linear, acyclic, unsubstituted C₃ to C₂₀ alkyl or C₃ to C₂₀ alkenyl,
m is an integer in the range of 3 to 13, and
R₂ is a linear, acyclic, unsubstituted C₁ to C₁₀ alkyl.

17. The concentrate according to claim 16, wherein the at least one sterol biosynthesis inhibitor is a triazole.

18. The concentrate according to claim 17, wherein the triazole is Tebuconazole.

19. A method of forming a stable, solvent-free, self-emulsifiable concentrate according to claim 1, the method comprising the step of mixing the at least one biocide with the at least one ethoxylated fatty acid alkyl ester of general formula (I).

20. A method of using the concentrate according to claim 1, the method comprising using the concentrate for the treatment of soil and plants, lawns and gardens, and buildings and other surfaces and structures where pests reside.

21. A kit for preparing the concentrate according to claim 1 comprising, as separate components, (a) the at least one biocide, and (b) the at least one ethoxylated fatty acid alkyl ester of general formula (I).
